(19) United States
(12) Patent Application Publication
(10) Pub. No.: US 2020/0339219 A1
(43) Pub. Date: Oct. 29, 2020

(54) CHAIN RING

(71) Applicant: TH INDUSTRIES CO., LTD., Taichung City (TW)

(72) Inventor: YUNG-CHI WU, Taichung City (TW)

(21) Appl. No.: 16/395,267

(22) Filed: Apr. 26, 2019

(51) Int. Cl. B62M 9/02; F16H 55/30; F16H 55/08

(52) U.S. Cl. CPC B62M 9/02; F16H 7/06; F16H 55/08; F16H 55/30

(57) ABSTRACT

A chain ring includes a chain ring body, a plurality of first teeth, a plurality of second teeth and at least one recess. The chain ring body has a radial outer circumference. The first teeth and the second teeth are respectively extended from the radial outer circumference and alternately arranged on the radial outer circumference of the chain ring body. Each second tooth includes a tooth tip and a tooth flank, and the tooth flank is extended between the tooth tip and the chain ring body, and in a first direction parallel to a rotation axis, the tooth flank includes a first surface and a second surface opposite to the first surface. The at least one recess is disposed on one of the first surface and the second surface of the tooth flank of at least one of the second tooth.

### FIELD OF THE DISCLOSURE

The present disclosure relates to a bicycle, and more particularly to a chain ring of a bicycle.

### BACKGROUND OF THE DISCLOSURE

A multi-speed bicycle has a transmission system as shown in FIG. 1. Please refer to FIG. 1, which illustrates a top view of an existing transmission system 100 for a multi-speed bicycle. The transmission system 100 of FIG. 1 is a 1X transmission system and includes a chain 110, a rear freewheel 120 and a front chain ring 130. The front chain ring 130 is a single chain ring and connects to a crank (not shown). The rear freewheel 120 connects to a rear wheel (not shown) and has a plurality of sprockets 121 stacked on each other.

The sizes of these sprockets 121 are different from each other. As shown in FIG. 1, the sprocket wheels 121 are arranged from top to bottom in order of size from large to small, as such, the uppermost sprocket 121 in FIG. 1 is the largest sprocket 121a having the largest diameter, and the lowermost sprocket 121 in FIG. 1 is the smallest sprocket 121b having the smallest diameter. The chain 110 is engaged with the rear freewheel 120 and the front chain ring 130 and is deflectable, so that the chain 100 can be bent in a direction along the rotation axis A12 of the rear freewheel 120 and the rotation axis A13 of the front chain gear 130. Thus, the chain 110 can be selectively engaged with one of the sprockets 121 for speed shifting.

However, the chain 110 bent along the directions of the rotation axis A12 and the rotation axis A13 may generate lateral stress, which may cause friction between the rear freewheel 120 and the chain 110 as well as between the front chain ring 130 and the chain 110. The greater bending range (along the direction of the rotation axis A12 and rotation axis A13) of the chain 110, the greater the lateral stress, thereby resulting greater friction. Once the friction is greater than a specific degree, not only a greater noise will be generated while riding the bicycle, the wear of the chain 110, the rear freewheel 120 and the front chain ring 130 is also accelerated, and even the risk that the chain 110 is detached from the rear freewheel 120 or the front chain ring 130 is increased.

### SUMMARY OF THE DISCLOSURE

The present disclosure provides a chain ring, and a part of the teeth of the chain ring have recesses to reduce the friction between the chain ring and a chain.

The present disclosure provides a chain ring applied to a bicycle, and the chain ring rotates about a rotation axis. The chain ring includes a chain ring body, a plurality of first teeth, a plurality of second teeth and at least one recess. The chain ring body has a radial outer circumference. The first teeth and the second teeth are respectively extended from the radial outer circumference and alternately arranged on a radial outer circumference of the chain ring body, each of the second teeth includes a tooth tip and a tooth flank extended between the tooth tip and the chain ring body. In a first direction parallel to the rotation axis, the tooth flank includes a first surface and a second surface opposite to the first surface. The at least one recess is disposed on the first surface or the second surface of the tooth flank of at least one of the second teeth.

In an embodiment of the present disclosure, along the first direction, each of the first teeth has a first thickness, each of the second teeth has a second thickness smaller than the first thickness.

In an embodiment of the present disclosure, a ratio of the first thickness to the second thickness may be between 1.5 and 3.

In an embodiment of the present disclosure, the bicycle includes a bicycle frame, the chain ring is mounted on a side of the bicycle frame, and the first surface of each of the second teeth is farther from the bicycle frame than the second surface in the first direction.

In an embodiment of the present disclosure, when viewed in a vertical direction to the rotation axis, the at least one recess include a first recess disposed on the first surface of the tooth flank of each of the second teeth and a second recess disposed on the second surface of the tooth flank of each of the second teeth, the first recess has a first recess bottom and a first axis passing through the first recess bottom and parallel to the rotation axis, and the second recess has a second recess bottom and a second axis passing through the second recess bottom and parallel to the rotation axis.

In an embodiment of the present disclosure, the first axis may be collinear with the second axis.

In an embodiment of the present disclosure, the first axis is non-collinear with the second axis.

In an embodiment of the present disclosure, each of the first recesses has a first depth corresponding to the first surface, each of the second recesses has a second depth corresponding to the second surface, and the first depth is greater than or equal to the second depth.

In an embodiment of the present disclosure, a ratio of the first depth to the second depth may be between 1 and 2.

In an embodiment of the present disclosure, the first recess is disposed apart from the chain ring body by a first distance, the second recess is disposed apart from the chain ring body by a second distance, and the first distance is smaller than the second distance.

In an embodiment of the present disclosure, a ratio of the first distance to the second distance may be between 0.5 and 0.8.

In an embodiment of the present disclosure, the at least one recess is only disposed on the first surface of the tooth flank of at least one of the second teeth.

In an embodiment of the present disclosure, a depth of each of the at least one recess is 5% to 10% of a thickness of each of the at least one second teeth.

In summary, since the tooth flank of the second tooth has recesses, the contact area between the sprockets and the chain can be effectively reduced when the chain of the bicycle is bent in the first direction due to speed shifting, and accordingly the friction can be decreased, thereby reducing noise and wear of the transmission parts while riding the bicycle. In addition, since only a part of the second tooth has the recess, the functions of guiding the chain and helping the first teeth to engage with the chain are not affected.

Other objectives, features and advantages of the disclosure will be further understood from the further technological features disclosed by the embodiments of the disclosure.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic side view of a transmission system of a multi-speed bicycle;

FIG. 2A is a schematic top view of a chain ring of an embodiment of the present disclosure;

FIG. 2B is a schematic cross-sectional view a chain ring of an embodiment of the present disclosure along the line A-A in FIG. 2A;

FIG. 3A is a schematic enlarged cross-sectional view of a second tooth of an embodiment of the present disclosure;

FIG. 3B is a schematic enlarged cross-sectional view of a second tooth of another embodiment of the present disclosure; and

FIG. 3C is a schematic enlarged cross-sectional view of a second tooth of another embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

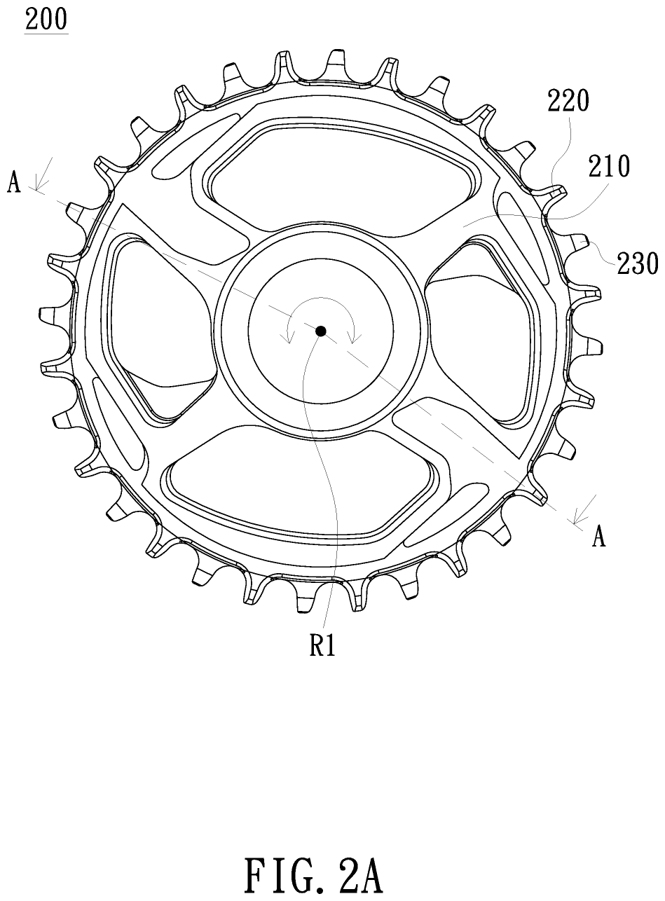

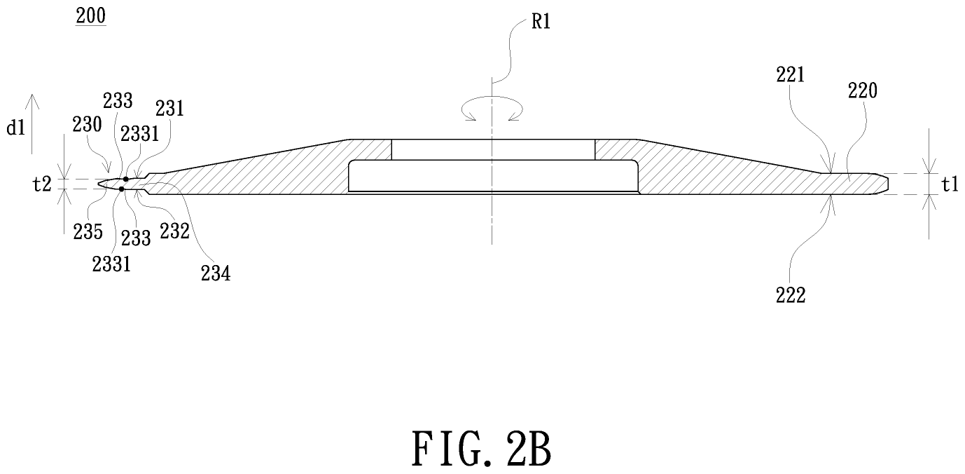

FIG. 2A is a schematic top view of a chain ring of an embodiment of the present disclosure. FIG. 2B is a schematic cross-sectional view a chain ring along the line A-A in FIG. 2A of an embodiment of the present disclosure. Please refer to FIG. 2A and FIG. 2B, the chain ring 200 of the present embodiment includes a chain ring body 210, a plurality of first teeth 220, a plurality of second teeth 230 and at least one recess 233. The chain ring 200 rotates about a rotation axis R1.

The first teeth 220 and the second teeth 230 are respectively extended from a radial outer circumference of the chain ring body 210. Specifically, the first teeth 220 and the second teeth 230 are alternately arranged on the radial outer circumference of the chain ring body 210. Each second tooth 230 includes a tooth flank 234 and a tooth tip 235, and the tooth flank 234 is extended between the tooth tip 235 and the chain ring body 210. In a first direction dl parallel to the rotation axis R1, the tooth flank 234 has a first surface 231 and a second surface 232 opposite to the first surface 231. The at least one recess 233 may be disposed on one of the first surface 231 and the second surface 232 of the tooth flank 234 of at least one of the second teeth 230. Each recess 233 has a recess bottom 2331 at a position farthest away from one of the first surface 231 and the second surface 232. The recesses 233 may be disposed on each second tooth 230, but is not limited there to. The recesses 233 may be disposed on part of the second teeth 230.

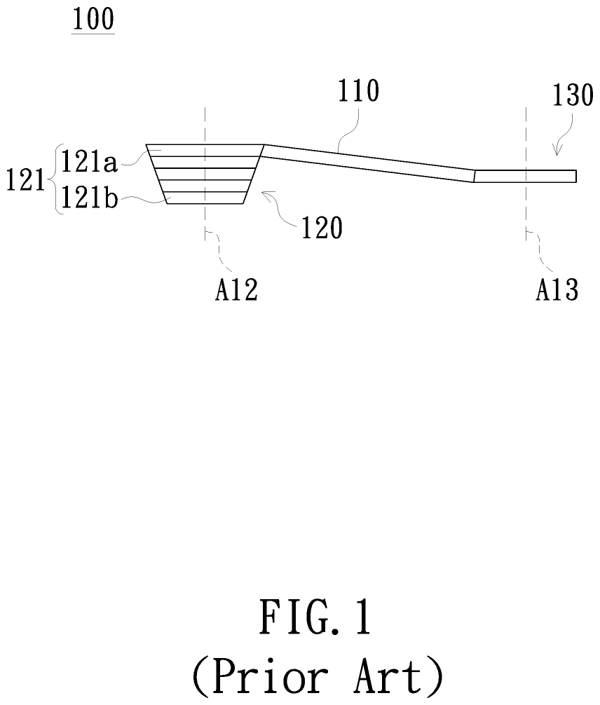

The chain ring 200 can be applied to a bicycle (not shown), for example, the chain ring 200 can be a front chain ring of a bicycle. The chain ring 200 may cooperate with a chain (such as the chain 110 in FIG. 1) and a plurality of stacked sprockets (such as sprockets 121 in FIG. 1) connected to the rear freewheel (such as the rear freewheel 120 of FIG. 1) of a bicycle to drive the rear freewheel.

In the first direction dl, each first tooth 220 of the chain ring body 210 has a first thickness t1, and each second tooth 230 of the chain ring body 210 has a second thickness t2. The first thickness t1 is the distance between a third surface 221 and a forth surface 222 of each first tooth 220. The second thickness t2 is the distance between the first surface 231 and the second surface 232 of each second tooth 230. The first thickness t1 is greater than the second thickness t2. For the chain ring 200, the first teeth 220 are the main structure for being engaged with the chain, so the first thickness t1 is preferably to correspond to the width of the gap of the chain for avoiding the chain being detached from the chain ring 200. As for the second teeth 230 alternately arranged with the first teeth 220, the second teeth 230 have functions for guiding the chain and helping the first teeth 220 to engage the chain. In order to reduce friction with the chain, the second thickness t2 of the second tooth 230 is preferably narrower than the width of the gap of the chain, so the second thickness t2 is smaller than the first thickness t1. For example, in the embodiment, the ratio of the first thickness t1 to the second thickness t2 may be between 1.5 and 3, but is not limited thereto.

When the bicycle is speed-shifted by a user, to change the chain ring or the sprocket which engaged with the chain, the chain will be bent along the first direction dl, and friction between the chain and the first tooth 220 as well as friction between the chain and the second tooth 230 will be increased. The greater bending of the chain, the greater friction between the chain and the first teeth 220 as well as between the chain and the second teeth 230 are resulted, which may generate noise and cause wear of the chain and the chain ring 200. Each second tooth 230 of the embodiment has the recesses 233, so the contact area between the chain and each second tooth 230 of the chain ring 200 is effectively reduced when the chain is bent along the first direction dl, thereby reducing the friction and the noise and avoiding the excessive wear of the chain ring 200 and the chain.

In the embodiment, the bicycle which the chain ring 200 is applied to can include a bicycle frame (not shown), and the chain ring 200 is mounted on a side of the bicycle frame. In the first direction dl, the first surface 231 of each second tooth 230 is farther from the bicycle frame than the second surface 232. As the above description, the recesses 233 can be disposed on one of the first surface 231 and the second surface 232 of the second tooth 230. Although the recesses 233 are illustrated on both the first surface 231 and the second surface 232 of the second tooth 230, the disclosure is not limited thereto. The recesses 233 may be disposed only on the first surface 231 or the second surface 232.

The contact area between the chain and the first surface 231 of each second tooth 230 is increased when the chain is bent toward the bicycle frame in the first direction dl, and the recess 233 disposed on the first surface 231 can decrease the contact area between the first surface 231 and the chain to reduce friction. The contact area between the chain and the second surface 232 of each second tooth 230 is increased when the chain is bent away from the bicycle frame in the first direction dl, and the recess 233 disposed on the second surface 232 can decrease the contact area between the second surface 232 and the chain to reduce friction.

Therefore, as shown in FIG. 1 and FIG. 2B, the chain ring 200 is connected to the rear freewheel 120 by the chain 110 when the chain ring 200 is applied to the front chain ring 130 of the transmission system 100 of a multi-speed bicycle. The chain 110 is bent toward the bicycle frame in the first direction dl when the chain 110 is connected to the largest sprocket 121a of the rear freewheel 120. Accordingly, the chain 110 may mainly rub against the first surface 231 of each second tooth 230, so the recess 233 may be disposed on the first surface 231, and the recess 233 may be or may not be disposed on the second surface 232.

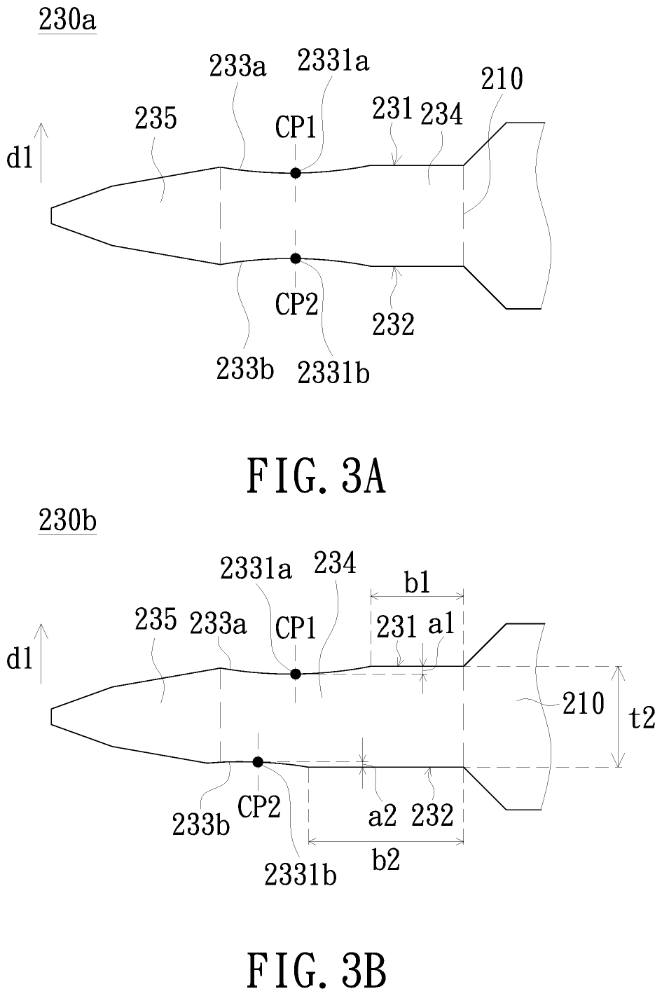

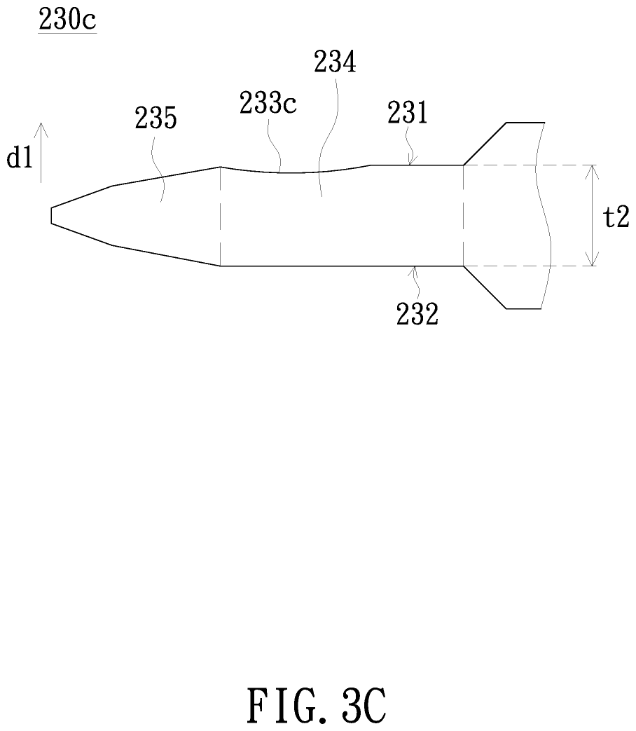

FIG. 3A is a schematic enlarged cross-sectional view of a second tooth 230a of an embodiment of the present disclosure. In the embodiment, the recess of each second tooth 230a includes a first recess 233a disposed on the first surface 231 of the tooth flank 234 and a second recess 233b disposed on the second surface 232 of the tooth flank 234. The first recess 233a has a first recess bottom 2331a at a position farthest from the first surface 231, and the first recess 233a has a first axis CP1 passing through the first recess bottom 2331a and parallel to the rotation axis R1 of FIG. 2B. The second recess 233b has a second recess bottom 2331b at a position farthest from the second surface 232, and the second recess 233b has a second axis CP2 passing through the second recess bottom 2331b and parallel to the rotation axis R1. In the embodiment, the first axis CP1 may be collinear with the second axis CP2. It should be noted that the first recess 233a is illustrated to be the same with the second recess 233b; however, the disclosure is not limited thereto. The depth and range of the first recess 233a can be different from those of the second recess 233b.

FIG. 3B is a schematic enlarged cross-sectional view of a second tooth 230b of another embodiment of the present disclosure. Please refer to FIG. 3B, the structure of the second tooth 230b of the present embodiment is similar to the structure or the second tooth 230a of FIG. 3A. For example, the second tooth 230b also has the first surface 231 and the second surface 232 same as in FIG. 3A. The main difference between the two is that in the present embodiment each first recess 233a has a first depth a1 corresponding to the distance from the first surface 231 to the first recess bottom 2331a, and each second recess 233b has a second depth a2 corresponding to the distance from the second surface 232 to the second recess bottom 2331b, wherein the first depth a1 may be greater than or equal to the second depth a2. Preferably, the ratio of the first depth a1 to the second depth a2 may be between 1 and 2, and each first depth a1 can be 5% to 10% of the second thickness t2, but is not limited thereto.

In the present embodiment showed in the FIG. 3B, the first axis CP1 may be non-collinear with the second axis CP2. In the present embodiment, the area of the first surface 231 of the tooth flank 234 occupied by the first recess 233a may be larger than the area of the second surface 232 occupied by the second recess 233b. The first recess 233a is disposed apart from the chain ring body 210 by a first distance b1, and the second recess 233b is disposed apart from the chain ring body 210 by a second distance b2. The first distance b1 may be smaller than the second distance b2 since the area of the first recess 233a is larger than the area of the second recess 233b. The ratio of the first distance b1 to the second distance b2 may be between 0.5 and 0.8, but is not limited thereto.

FIG. 3C is a schematic enlarged cross-sectional view of a second tooth 230c of another embodiment of the present disclosure. Please refer to FIG. 3C, the structure of the second tooth 230c of the present embodiment is similar to that of the second tooth 230b of the embodiment of FIG. 3B. For example, the features such as the depth and range of the recess 233c of the second tooth 230c and the region of the second tooth 230c where the recess 233c is located may be the same with those of the first recess 233a of FIG. 3B and have the same functions. The main difference between the two is that the recess 233c is only disposed on the first surface 231 of each second tooth 230c in the present embodiment. Since the first surface 231 is the main surface having a friction with the chain, the second surface 232 may be provided with no recess 233c in some cases such as when friction between the second surface 232 and the chain can be ignored.

In summary, since the tooth flank of the second tooth has recesses, the contact area between the sprockets and the chain can be effectively reduced when the chain of the bicycle is bent in the first direction due to speed shifting, and accordingly the friction can be decreased, thereby reducing noise and wear of the transmission parts while riding the bicycle. In addition, since only a part of the second tooth has the recess, the functions of guiding the chain and helping the first teeth to engage with the chain are not affected.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A chain ring, applied to a bicycle, the chain ring rotating about a rotation axis, and the chain ring comprising:
a chain ring body, having a radial outer circumference;
a plurality of first teeth and a plurality of second teeth, wherein the first teeth and the second teeth are respectively extended from the radial outer circumference and alternately arranged on the radial outer circumference of the chain ring body, each of the second teeth comprises a tooth tip and a tooth flank, wherein the tooth flank is extended between the tooth tip and the chain ring body, wherein in a first direction parallel to the rotation axis, the tooth flank comprises a first surface and a second surface opposite to the first surface; and
at least one recess, disposed on one of the first surface and the second surface of the tooth flank of at least one of the second teeth.

2. The chain ring according to claim 1, wherein along the first direction, each of the first teeth has a first thickness, each of the second teeth has a second thickness smaller than the first thickness.

3. The chain ring according to claim 2, wherein a ratio of the first thickness to the second thickness is between 1.5 and 3.

4. The chain ring according to claim 1, wherein the bicycle comprises a bicycle frame, the chain ring is mounted on a side of the bicycle frame, and the first surface of each of the second teeth is farther from the bicycle frame than the second surface in the first direction.

5. The chain ring according to claim 1, wherein when viewed in a vertical direction to the rotation axis, the at least one recess comprise a first recess disposed on the first surface of the tooth flank of each of the second teeth and a second recess disposed on the second surface of the tooth flank of each of the second teeth, the first recess has a first recess bottom and a first axis passing through the first recess bottom and parallel to the rotation axis, and the second recess has a second recess bottom and a second axis passing through the second recess bottom and parallel to the rotation axis.

6. The chain ring according to claim 5, wherein the first axis is collinear with the second axis.

7. The chain ring according to claim 5, wherein the first axis is non-collinear with the second axis.

8. The chain ring according to claim 5, wherein each of the first recesses has a first depth corresponding to the first surface, each of the second recesses has a second depth corresponding to the second surface, and the first depth is greater than or equal to the second depth.

9. The chain ring according to claim 8, wherein a ratio of the first depth to the second depth is between 1 and 2.

10. The chain ring according to claim 7, wherein the first recess is disposed apart from the chain ring body by a first distance, the second recess is disposed apart from the chain ring body by a second distance, and the first distance is smaller than the second distance.

11. The chain ring according to claim 10, wherein a ratio of the first distance to the second distance is between 0.5 and 0.8.

12. The chain ring according to claim 4, wherein the at least one recess is only disposed on the first surface of the tooth flank of at least one of the second teeth.

13. The chain ring according to claim 12, wherein a depth of each of the at least one recess is 5% to 10% of a thickness of each of the at least one second teeth.
